(19) United States
(12) Patent Application Publication
(10) Pub. No.: US 2018/0171824 A1
(43) Pub. Date: Jun. 21, 2018

(54) METHOD FOR COOLING A TURBO MACHINE

(71) Applicant: SIEMENS AKTIENGESELLSCHAFT, MÜNCHEN (DE)

(72) Inventors: MARC BOROWSKI, MOERS (DE); OLIVER STAWARSKI, NEUSS (DE)

(21) Appl. No.: 15/738,589

(22) PCT Filed: Jun. 8, 2016
(86) PCT No.: PCT/EP2016/062966

§ 371 Date: Dec. 21, 2017

(30) Foreign Application Priority Data
Jun. 25, 2015 (EP) 15173772.3

(51) Int. Cl. F01D 25/12; F01D 21/00; F01P 7/02; G06F 1/20

(52) U.S. Cl. CPC F01D 25/12; F01D 21/003; F01P 7/02; G06F 1/206; F05D 2270/701; F05D 2260/20; F05D 2270/706; F05D 2270/705; F05D 2220/31

(57) ABSTRACT

Provided is a method for rapidly cooling a steam turbine, wherein ambient air is introduced into the steam turbine through a valve via an evacuation unit, resulting in cooling of the steam turbine, the rate of cooling being adjusted by an automation system including a controller.

### CROSS-REFERENCE TO RELATED APPLICATIONS

This application claims priority to PCT Application No. PCT/EP2015/062966, having a filing date of Jun. 8, 2016, based on European Application No. 15173772.3, having a filing date of Jun. 25, 2015, the entire contents both of which are hereby incorporated by reference.

### FIELD OF TECHNOLOGY

The following relates to a method for cooling a turbo machine, wherein the turbo machine has an inlet and an outlet, wherein the outlet is fluidically connected to an evacuation unit, wherein the inlet is fluidically connected to an air device for feeding in coolant, wherein the evacuation unit is embodied in such a way that the coolant flows at a coolant through flow rate through the turbo machine.

Furthermore, the following relates to an automation system for carrying out a method.

### BACKGROUND

Turbo machines, such as e.g. steam turbines, are subjected to high thermal stresses. Steam with a comparatively high thermal energy level is generally made to flow through steam turbines via an inlet. During continuous operation, the temperatures of the steam turbine components, such as e.g. the housing, are at a high, constant temperature. Generally, when turbo machines are operating it is necessary to ensure that the change in temperature per unit of time does not exceed certain limiting values so that the service life of the component is not excessively shortened. For inspection purposes, it is necessary for the steam turbines to be completely cooled. However, after they have been shut down steam turbines are still at operating temperature and cool comparatively slowly owing to thermal insulation. One possible way of speeding up the cooling is to cause ambient air to flow through the steam turbine after the powered operation has ended, a partial vacuum being generated in the turbine condenser with an evacuation unit and bringing about a forced flow of the ambient air through the steam turbine. The flow of the ambient air through the steam turbine takes place at a specific through flow rate, it being necessary to ensure that the through flow rate is selected such that permissible cooling rates are not exceeded. For this purpose, the through flow rate is adapted to the permissible cooling rate by the manual adjustment of shut-off valves. This is done during the entire cooling time period. It is disadvantageous here that continuous occupation of the control room is necessary. Furthermore, the operating personnel must also monitor to ensure that no abnormal operating states occur during the cooling.

The operating personnel cyclically read off the component temperature on an operator control and observation system. The component temperatures are compared with previously determined data, and the shut-off valves which control the through flow rate of the ambient air are correspondingly adjusted. This can be done either in situ by manual operator control or by means of the operator control and observation system. If the cooling rate is slower than permitted, the shut-off valves are opened somewhat wider. If the cooling rate is faster than permitted, the shut-off valves are closed somewhat further.

This procedure is time-consuming. Embodiments of the invention attempt to remedy this.

This is achieved by means of a method for cooling a turbo machine, wherein the turbo machine has an inlet and an outlet, wherein the outlet is fluidically connected to an evacuation unit, wherein the inlet is fluidically connected to an air device for feeding in coolant. Wherein the evacuation unit is embodied in such a way that the coolant flows at a coolant through flow rate through the turbo machine, wherein permissible cooling rates of the turbo machine are determined, wherein actual cooling rates of the turbo machine are detected, wherein the permissible cooling rate and the actual cooling rate are compared with an automation system, and the through flow rate of coolant is controlled with the automation means.

### SUMMARY

An aspect relates to an automation system for carrying out the method.

Embodiments of the invention are therefore based on the approach of using automation so that the operating personnel are relieved of the need to perform repetitive activities. For this purpose, an automation system is considered with which the position of the shut-off valves with which the through flow rate of coolant can be controlled are positioned by means of an electronic controller which is part of the steam turbine control equipment. The automation system therefore detects the current actual cooling rate and compares it with a set permissible value. A controller, in particular a position controller, subsequently positions the shut-off valve in order to control the through flow rate of coolant.

If the permissible cooling rate is exceeded, arising e.g. as a result of a fault in the control circuit, the operating personnel is alerted to this state by an alarm.

With embodiments of the invention it is then possible always to control the cooling of a turbo machine at the optimum rate. This means that delays as a result of an excessively low shut-off valve opening are avoided, and permissible limits are prevented from being exceeded by an excessively large valve opening.

Advantageous developments are specified in the dependent claims.

The turbo machine is therefore embodied as a steam turbine in a first advantageous development.

Further examples of a turbo machine are compressors or gas turbines.

In one advantageous development, the steam turbine has a high-pressure partial turbine, a medium-pressure partial turbine and/or a low-pressure partial turbine. The high-pressure partial turbine is designed for live steam temperatures here. The live steam temperature of the live steam is the temperature which the steam which is flowing via a live steam line to the high-pressure partial turbine has at the output of the steam generator. Downstream of the high-pressure partial turbine, the steam flows to an intermediate super-heater unit where it is heated again to a relatively high temperature and subsequently flows into the medium-pressure partial turbine. After flowing through the medium-pressure partial turbine, the steam flows directly to a low-pressure partial turbine and from there to a condenser via an overflow line.

The method for cooling the steam turbine can be used in the high-pressure partial turbine, the medium-pressure partial turbine and the low-pressure partial turbine overall. It is also possible to use the method for cooling only in a high-pressure partial turbine, only in a medium-pressure partial turbine or only in a low-pressure partial turbine.

The inlet of the turbo machine is embodied with a valve, wherein the valve controls the through flow rate of coolant.

In one advantageous development, the valve is embodied as a steam valve in the inlet.

Ambient air is advantageously used as the coolant.

In one advantageous development, the permissible cooling rate is calculated by means of a finite element method, determined empirically or determined by testing.

The actual cooling rate is advantageously determined from comparison data, measured or determined by prediction.

Exemplary embodiments of the invention are described below with reference to the drawings. The latter are not intended to represent the exemplary embodiments to scale but instead the drawings serve only for the purpose of explanation and are executed in a schematic and/or slightly distorted form. For additions to the teachings which can be discerned in the drawing, reference is made to the relevant prior art.

### BRIEF DESCRIPTION

Some of the embodiments will be described in detail, with references to the following figures, wherein like designations denote like members, wherein:

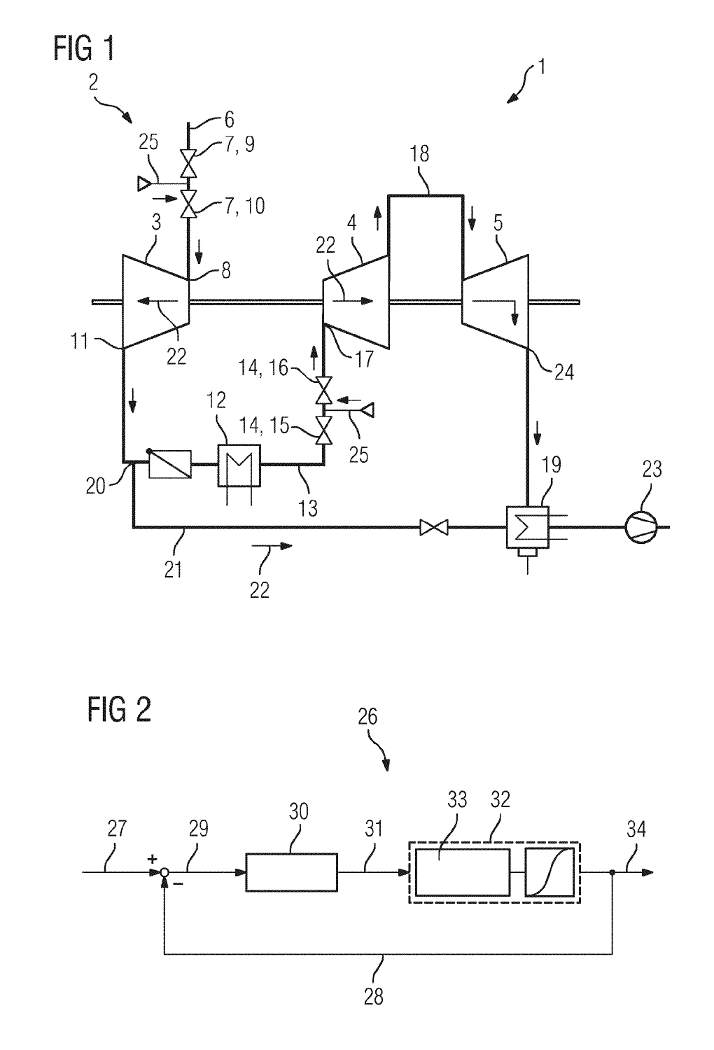

FIG. 1 shows a schematic illustration of a steam turbine system; and

FIG. 2 shows a schematic illustration of the control system.

### DETAILED DESCRIPTION

FIG. 1 shows a schematic illustration of a power plant 1 comprising a turbo machine which is embodied as a steam turbine 2, wherein the steam turbine comprises a high-pressure partial turbine 3, a medium-pressure partial turbine 4 and a low-pressure partial turbine 5. Live steam flows from a steam generator (not illustrated in more detail) into an inlet 8 of the high-pressure partial turbine 3 via a live steam line 6 and via a shut-off valve 7. The shut-off valve 7 is embodied in the exemplary embodiment as a control valve 9 and a quick-action valve 10. In alternative embodiments, the control valve 9 and the quick-action valve 10 can also be arranged the other way round.

In the high-pressure partial turbine 3, the live steam which has a high thermal energy level expands. This high thermal energy level is converted into rotational energy of a rotor (not illustrated in more detail). In this context, the live steam cools to a relatively low temperature, wherein a relatively low pressure is set and flows via an outlet 11 to a reheater 12 which reheats the steam to a relatively high temperature. The steam which is heated in this way is fed via a medium-pressure shut-off valve 14 through a hot reheating line 13 to the medium-pressure partial turbine 4. The medium-pressure shut-off valve 14 is embodied as a medium-pressure control valve 15 and a medium-pressure quick-action valve 16. The steam flows to the medium-pressure partial turbine 4 via a medium-pressure inlet 17. The steam from the medium-pressure partial turbine 4 flows via an overflow line 18 to an inlet of the low-pressure partial turbine 5 to the condenser 19. In the condenser 19, the steam condenses to form water and is fed back to the steam generator via a line (not illustrated in more detail).

The power plant 1 also comprises a junction 20. At this junction 20 a bypass line 21 is arranged which forms a fluidic connection between the outlet 11 of the high-pressure partial turbine 3 and the condenser 19.

The power plant 1 is also embodied with an evacuation unit 23, wherein the evacuation unit 23 is fluidically connected to the outlet 11 and an outlet 24 of the low-pressure partial turbine 5. The evacuation unit 23 is embodied in such a way that there is a partial vacuum in the condenser 19, with the result that a coolant located in the steam turbine 2 passes to the condenser 19 in the direction of the arrow 22. The coolant, in particular ambient air, passes via a coolant line 25 into the shut-off valve 7 or medium-pressure shut-off valve 14 and leads to a forced cooling system by means of ambient air through the coolant line 25 and the shut-off valves 7 and 14 and the inlet 8 and 17 through the high-pressure partial turbine 3 and medium-pressure partial turbine 4.

The evacuation device 23 is embodied in such a way that the coolant flows with a through flow rate of coolant through the steam turbine 2.

The power plant 1 is also embodied with an automation system (not illustrated) which initially determines permissible cooling rates of the steam turbine 2. The permissible cooling rates can be calculated by means of a finite element method, determined empirically or determined by testing. In addition, the actual cooling rate of the steam turbine 2 is detected with the automation system. This is done by means of a measurement, on the basis of averaging with comparison data or by prediction.

In the subsequent step, the automation system compares the permissible cooling rate with the actual cooling rate and controls the through flow rate of coolant through the coolant line 25.

This control can be carried out by means of the stroke setting in the shut-off valve 7 and with the medium-pressure shut-off valve 14. If the cooling rate is slower than is permissible, the shut-off valve 7, 14 is opened somewhat wider. If the cooling rate is faster than is permissible, the shut-off valve 7, 14 is closed somewhat further.

In order to monitor for abnormal operating states, e.g. contact between rotating parts and non-rotating parts, the rotation speed of the turbine rotor must be continuously monitored.

If the permissible cooling rate is exceeded, e.g. in the event of a fault in the control circuit, the operating personnel is alerted to the state by an alarm.

The automation system is embodied with a controller which is illustrated in FIG. 2.

The controller 26 according to FIG. 2 has a set point value input which is formed by the set point cooling rate (K/h). An actual value 28, which is formed by the actual cooling rate (K/h) is subtracted from the set point value 27. The difference between the set point value input 27 and the actual value 28 is fed as a control error 29 to a controller which can be referred to as a cooling controller. The controller 30 can be embodied as a P, PI or PID controller. The output of the controller 31 is fed as a manipulative variable, referred to as a position set point value, to a controlled system 32. The controlled system 32 is formed by a position controller of the turbine valves 33. The output of the control system is referred to as a control variable 34 and is formed by the cooling rate.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for cooling a turbo machine, wherein the turbo machine has an inlet and/or an outlet,
fluidically connecting the outlet to an evacuation unit,
wherein the inlet is fluidically connected to an air device for feeding in coolant,
wherein the evacuation unit is embodied in such a way that the coolant flows at a coolant through flow rate through the turbo machine,
determining permissible cooling rates of the turbo machine,
detecting an actual cooling rate of the turbo machine,
comparing the permissible cooling rate and the actual cooling rate with an automation system, and the through flow rate of coolant is controlled with the automation system.

2. The method as claimed in claim 1,
wherein the turbo machine is embodied as a steam turbine.

3. The method as claimed in claim 2,
wherein the steam turbine has a high-pressure partial turbine, a medium-pressure partial turbine and/or a low-pressure partial turbine.

4. The method as claimed in claim 1,
wherein the through flow rate of coolant through the air device is controlled with a valve.

5. The method as claimed in claim 4,
wherein the valve is embodied as a steam valve in the inlet.

6. The method as claimed in claim 1,
wherein ambient air is used as the coolant.

7. The method as claimed in claim 1,
wherein the permissible cooling rate is calculated by means of a finite element method or determined empirically or determined by testing.

8. The method as claimed in claim 1,
wherein the actual cooling rate is measured, determined from comparison data or determined by prediction.

9. The method as claimed in claim 1,
wherein the automation system is embodied with a controller,
wherein a set point cooling rate (K/h) is used as a set point value,
wherein the following applies:
set point cooling rate ≤permissible cooling rate,
wherein the actual cooling rate is used as the actual value.

10. The method as claimed in claim 9,
wherein the through flow rate of coolant is used as a manipulative variable.

11. The method as claimed in claim 9,
wherein the valve setting of the steam valve is used as a manipulative variable.

12. The method as claimed in claim 9,
wherein a P, PI or PID controller is used as the controller.

13. The method as claimed in claim 1,
wherein an alarm goes off if the permissible cooling rate is exceeded or undershot.

14. An automation system for carrying out a method as claimed in claim 1.
